(19) United States
(12) Patent Application Publication
(10) Pub. No.: US 2012/0144858 A1
(43) Pub. Date: Jun. 14, 2012

(54) FLEXIBLE REFRIGERATION CONNECTION TUBE

(76) Inventors: Colby Logan, Grenada, MS (US); James Timbs, Winoma, MS (US)

(21) Appl. No.: 13/155,883

(22) Filed: Jun. 8, 2011

Related U.S. Application Data
(60) Provisional application No. 61/422,585, filed on Dec. 13, 2010.

(51) Int. Cl. F25B 39/02; F25D 23/00; B23P 15/26; F16L 11/00

(52) U.S. Cl. 62/515; 138/121; 138/122; 62/529; 29/890.035

(57) ABSTRACT

A refrigeration connection tube. The tube comprises a flexible section of tubing that includes a ribbing. The ribbing circumscribes the flexible section of tubing in a direction that is substantially perpendicular to a long axis of the flexible section of tubing. The ribbing traverses an entire thickness of the flexible section of tubing.

### CROSS REFERENCE TO RELATED APPLICATION

This application claims the benefit of U.S. Provisional Application Ser. No. 61/422,585, filed by Colby W. Logan, et al. on Dec. 13, 2010, entitled “FLEX TUBE,” commonly assigned with this application and incorporated herein by reference.

### TECHNICAL FIELD

This application is directed, in general, to a flexible refrigeration tube, to space conditioning systems having the flexible tube and methods of servicing the system that use the flexible tube.

### BACKGROUND

Many space conditioning systems must be rated to operate at high internal flow rates and pressures of refrigerant (e.g., 400 psi and UL ratings of 2000 psi) and therefore some of the components of the system (e.g., evaporator, compressor and condenser components) are often interconnected with thick-walled tubing. Gaining service access to another component often requires that refrigerant be recovered from the system and the tubing be cut. Then, the tubing has to be reconnected and the refrigerant reintroduced into the system. It would be desirable if servicing could be accomplished without having to perform these steps.

### SUMMARY

One embodiment of the present disclosure is a refrigeration connection tube. The tube comprises a flexible section of tubing that includes a ribbing. The ribbing circumscribes the flexible section of tubing in a direction that is substantially perpendicular to a long axis of the flexible section of tubing. The ribbing traverses an entire thickness of the flexible section of tubing.

Another embodiment of the present disclosure is a space conditioning system for conditioning air within an enclosed space. The system comprises a refrigerant-circulating component and the above-described refrigeration connection tube connected to the refrigerant-circulating component.

Another embodiment of the present disclosure is a method. The method comprises connecting the above-described refrigeration connection tube to a refrigerant-circulating component of a space conditioning system.

### BRIEF DESCRIPTION OF THE DRAWINGS

Reference is now made to the following descriptions taken in conjunction with the accompanying drawings, in which:

FIGS. 1A and 1B present perspective views of an example embodiment of a refrigeration connection tube of the disclosure;

FIG. 2 presents a sectional view of the flexible section of tubing 110 of the refrigeration connection tube 100 depicted in FIG. 1;

FIG. 3 presents a sectional view, analogous to that shown in FIG. 2, of a different example embodiment of a refrigeration connection tube of the disclosure;

FIG. 4A presents a front view of an example space conditioning system of the disclosure, the system having any of the embodiments of the refrigeration connection tube discussed in the context of FIGS. 1A-3;

FIG. 4B presents a side view of the example space conditioning system depicted in FIG. 4A; and

FIG. 5 presents a flow diagram of an example method of servicing a space conditioning system, such as any of the systems discussed in the context of FIGS. 4A-4B.

### DETAILED DESCRIPTION

Embodiments of the present disclosure provide a refrigeration connection tube that has a flexible section that includes a ribbing. The flexible section facilitates the servicing components of a space conditioning system without having to cut the connection tubing or drain out refrigerant and reconnect the tubing and reintroduce the refrigerant.

It was surprising that a section of tubing having a ribbing could be used as part of a refrigeration connection tube because it was believed that ribbed tubing would not be able to tolerate the high burst pressure requirements for tubing used in modern space conditioning systems.

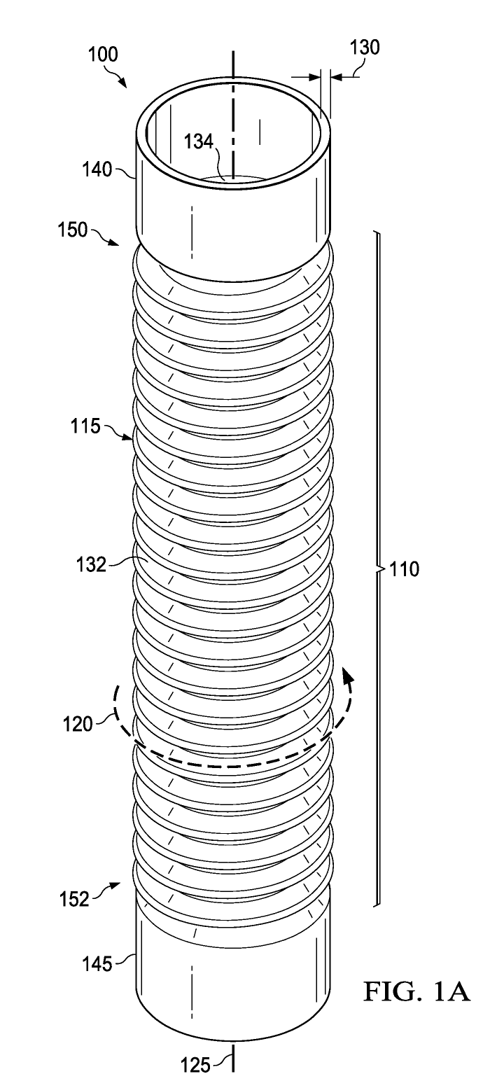

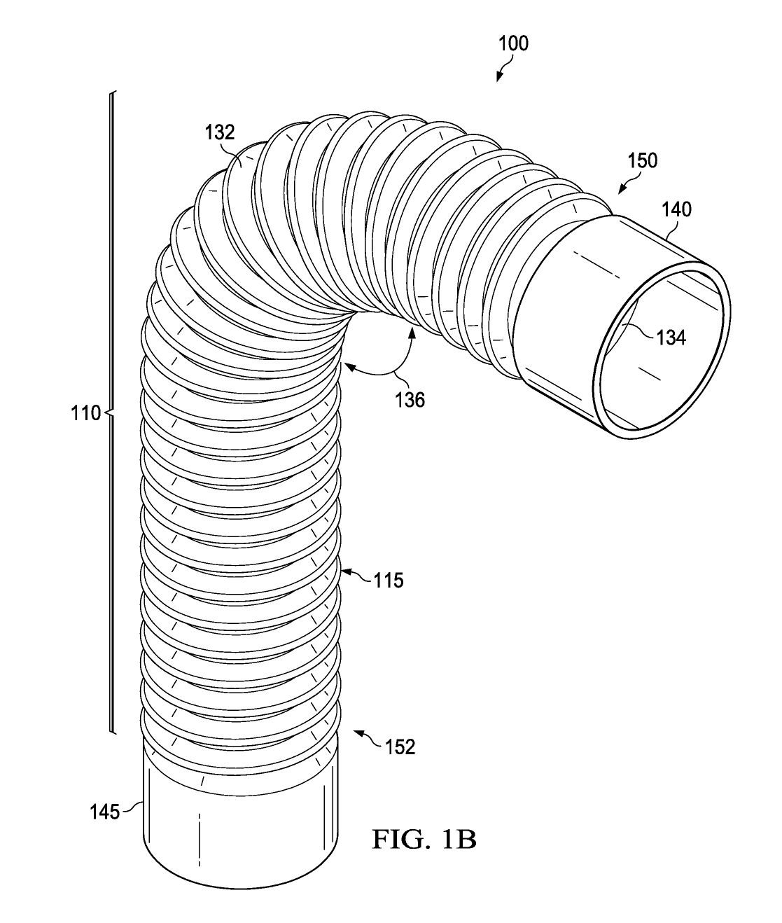

FIGS. 1A and 1B presents perspective views of an example embodiment of a refrigeration connection tube 100 of the disclosure. The tube 100 comprises a flexible section of tubing 110 that includes a ribbing 115. The ribbing 115 circumscribes the tubing 110 in a direction 120 that is substantially perpendicular to a long axis 125 of the flexible section of tubing 110 and the ribbing 115 also traverses an entire thickness 130 of the tubing section 110. That is, the ribbing 115 is visible on both the external surface 132 and the internal surface 134 of the flexible section of tubing 110.

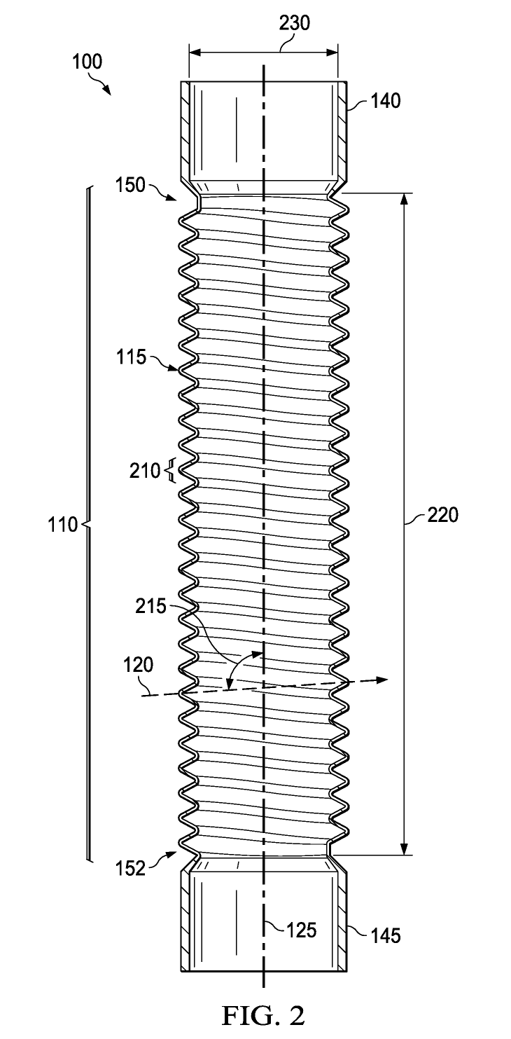

The term substantially perpendicular direction 120 to the long axis 125, as used herein, refers to the direction 120 of outer ridges of the ribbing 115 circumscribing the flexible section of tubing 110 with respect to the long axis 125. For example, FIG. 2 presents a sectional view of the flexible section of tubing 110 of the refrigeration connection tube 100 depicted in FIG. 1. As illustrated, the direction 120 of the ridges 210 of the ribbing 115 circumscribing the flexible section of tubing 110 forms an angle 215 in a range of about 45 to 125 degrees with respect to the long axis 125. In some embodiment the angle 215 is in a range of about 80 to 100 degrees.

In some embodiments, as illustrated in FIG. 1B, the flexible section of tubing 110 is configured to be reversibly bendable to form an angle 136 of at least about 45 degrees, more preferably at least about 70 degrees, and even more preferably, at least about 90 degrees. That is, the flexible section of tubing 110 can flexed from straight (FIG. 1A), to bent (FIG. 1B), to straight (FIG. 1A) orientations without crimping the tubing section 110.

As further illustrated in FIGS. 1A and 2, in some embodiments, the ribbing 115 spirals in a direction that follows the long axis 125 of the flexible section of tubing 110. For instance, in some cases, to facilitate having adequate flexibility, the ribbing 115 that spirals around the flexible section of tubing 110 makes at least one turn for every one-inch-length 220 along the long axis 125 the tubing section 110. In some preferred embodiments, the ribbing 115 makes about three to five turns per one-inch-length 220 along the long axis 125 of the tubing section 110.

In other cases as illustrated in FIGS. 1A and 2, the ribbing 115 can have one continues ridge 210 that spirals around the entire length 220 of the flexible section of tubing 110. In other cases, the ribbing 115 can have discontinuous ridges 210 that each separately spiral around at least a portion of tubing section 110. In some cases, the discontinuous ridges 210 could be arranged in series such that the ribbing 115 is present over the entire length 220 of the tubing section 110, although in other cases, portions of the discontinuous ridges 210 could be parallel to each other.

In some cases, to facilitate having adequate flexibility, the ribbing 115 circumscribes the flexible section of tubing 110 at least one turn for every one-inch-length 220 along the long axis 125 of the tubing section 110.

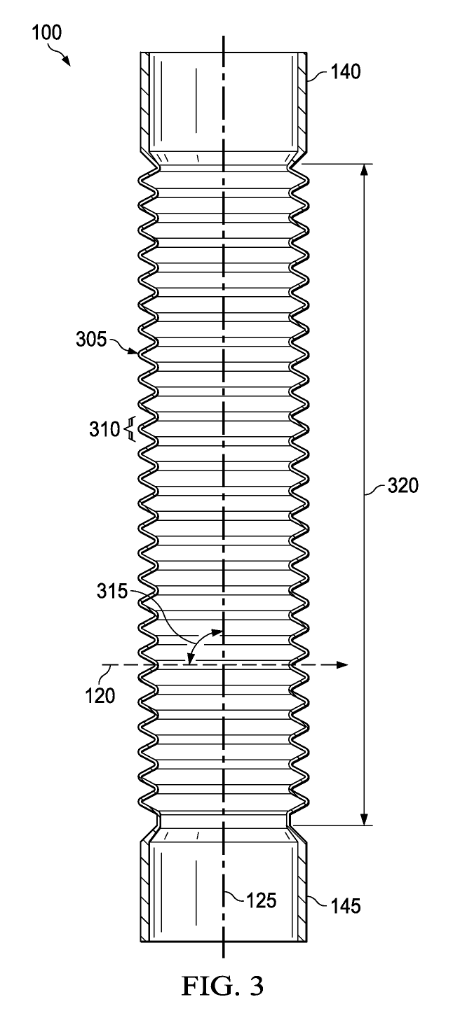

FIG. 3 presents a sectional view, analogous to that shown in FIG. 2, of a different example embodiment of a refrigeration connection tube 100 of the disclosure. As illustrated in FIG. 3, in some embodiments, the ribbing 115 includes a plurality of independent ribs 305 that each independently circumscribes the flexible section of tubing 110. In such embodiments, for instance, the direction 120 of the ridges 310 of the independent ribs 305 can each circumscribe the flexible section of tubing 110 in a direction 125 that forms an angle 315 of about 90 degrees with respect to the long axis 125 of the tubing section 110.

In some embodiments, such as shown in FIG. 3, to facilitate having sufficient flexibility in the flexible tubing section 110, at least one of the independent ribs 305 is located along every one-inch-length 320 of the long axis 125, and in some cases, there are about two to five of the independent ribs 305 for every one-inch-length 320.

In some cases the flexible section of tubing 110 is composed of aluminum or an aluminum alloy, while in other cases it is composed of copper or a copper alloy. Based on the present disclosure, one skilled in the art would be familiar with other types of material that the flexible section of tubing 110, and other parts of the refrigeration connection tube 110, could be composed of.

In some cases to facilitate have sufficient mechanical strength to meet a burst pressure requirement, the flexible section of tubing 110 (e.g., composed of copper or copper alloy) has a thickness 130 of at least about 0.035 inches.

In some cases, to facilitate having a sufficient flow rate of refrigerant fluid therein, the flexible section of tubing 110 has an internal diameter 230 of about 0.75 inches.

As illustrated in FIG. 1 in some embodiments of the tube 100, to facilitate replacement or retrofitting, smooth sections of non-ribbed end-fittings 140, 145 are brazed to the ends 150, 152 of the flexible section of tubing 110.

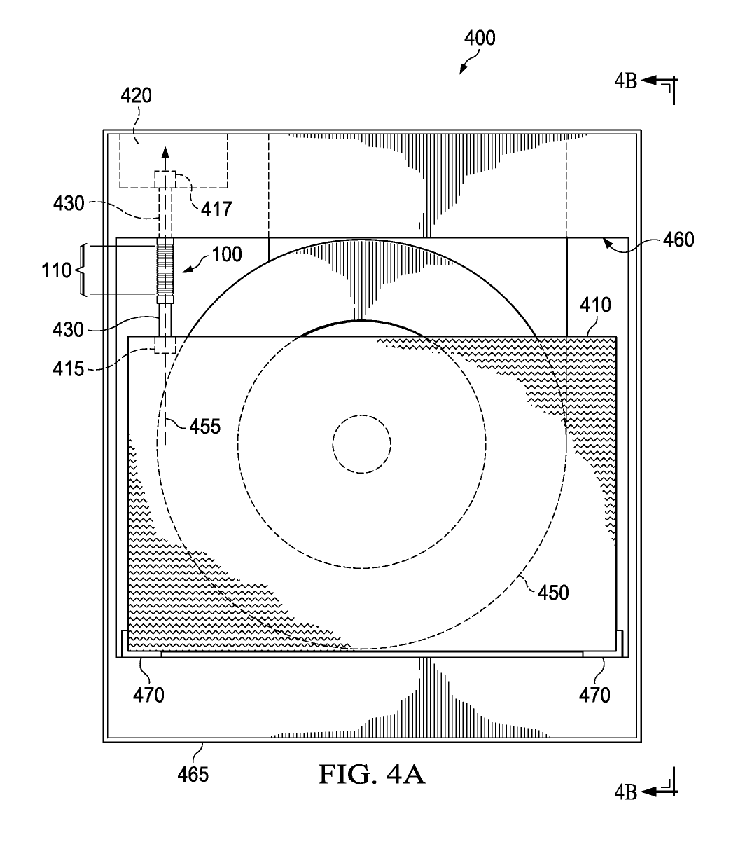

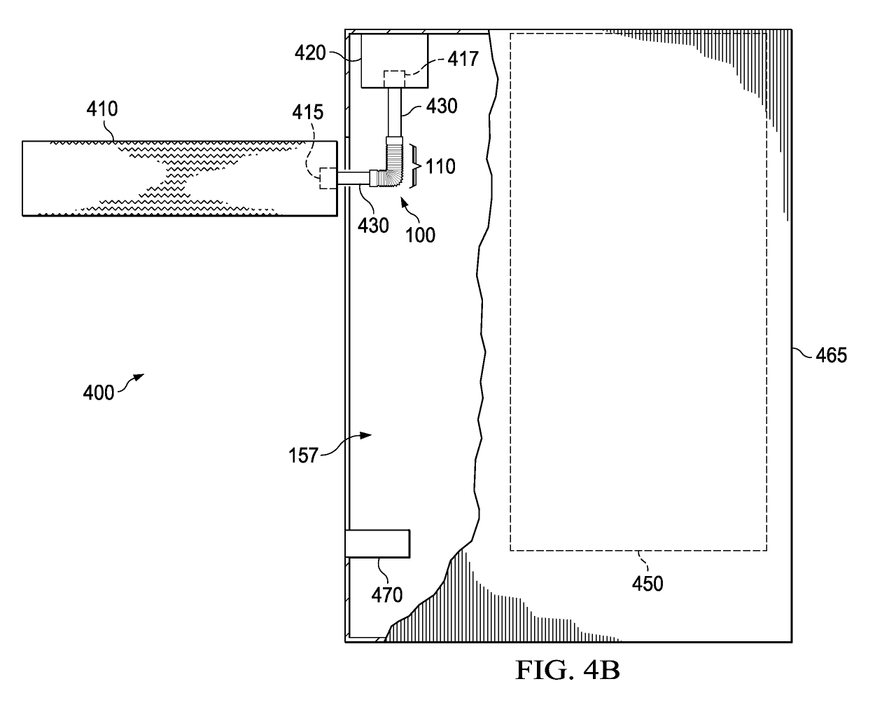

Another embodiment of the present disclosure is a space conditioning system, for conditioning air within an enclosed space. FIG. 4A presents a front view of an example space conditioning system 400 of the disclosure. FIG. 4B presents a cross-sectional view of the example space conditioning system 400 depicted in FIG. 4A along view line 5.

Turning to FIG. 4A, the system 400 comprises a refrigerant-circulating component 410 and a refrigeration connection tube 100 connected to the refrigerant-circulating component 410. The refrigeration connection tube 100 can comprise any of the embodiments of the refrigeration connection tube 100 discussed in the context of FIGS. 1A-3. For instance, at least a section 110 of the refrigerant tubing 100 is flexible, the flexible section of tubing 110 including a ribbing 115 (FIG. 1A). The ribbing 115 circumscribes the flexible section of tubing in a direction 120 that is substantially perpendicular to a long axis 125 of the flexible section of tubing 110 and the ribbing 115 traverses an entire thickness 135 of the flexible section of tubing 110 (FIG. 1A).

Example embodiments of the system 400 include compact air handling systems, such as described in U.S. patent application Ser. No. 12/984,349, filed on. Jan. 4, 2011, by Logan and Schmidt, which is incorporated by reference herein in its entirety. The use of the flexible section of tubing 110 in such compact systems is beneficial because access to internal component, e.g., through side or back panels may not be possible, e.g., because the whole systems 400 or part of the system 400 is mounted in a small space (e.g., a closet).

In some embodiments of the system 400, the refrigerant-circulating component 410 is an evaporator subunit and the refrigerant tubing 100 is part of a suction line that connects an outlet 415 of the evaporator subunit to an inlet 417 of a compressor subunit 420. As illustrated in FIG. 4A, in certain preexisting systems 400, where the existing line 430 does not have the disclosed the refrigerant tube 100, a portion of the existing line 430 (e.g., a suction line in some cases) can be cut out and the refrigerant tube 100 can brazed to ends of the remaining portions of line 430. For example, the tube 100 having smooth non-ribbed end fittings 140, 145 (FIG. 1) attached to the flexible section of tubing 110, can be configured so that end fitting 140, 145 fit over cut ends of the cut line 430 and then soldered in place to become part of a retrofitted line 430. One skilled in the art, based on the disclosure, would appreciate the different ways to connect the tube 100 to the line 430. In other embodiments, the flexible section of tubing 110 can be included in the original configuration of the system 400.

FIG. 4B illustrates a side view of the system 400 with the flexible section of tubing 110 in a reversibly bent configuration. Bending the flexible section of tubing 110 is useful when servicing the refrigerant-circulating component 410 that is connected to the refrigeration connection tube 420, or a different component 450 (e.g., a blower motor) of the system 400 whose access is blocked by the refrigerant-circulating component 410 or by the refrigeration connection tube 100. For instance bending the flexible section of tubing 110 with evaporator subunit 410 still attached thereto, e.g. so that the refrigerant-circulating component 410 can be moved out of an opening 460 of a cabinet 465 of the system 400, can facilitate access to the different component 450 located behind the evaporator subunit 410. Moreover, the different component 450 can be serviced without having to break a refrigerant circulation pathway 455, e.g., between the evaporator subunit 410 and tube 100, thereby improving the efficiency of servicing.

The above example was presented in the context of a compact air handling system with an evaporator subunit connected to the tube. However, based on the present disclosure, one skilled in the art would appreciate that other kinds of refrigerant-circulating components, in other types of space conditioning systems (e.g., home HVAC systems, commercial rooftop systems) could be connected to the refrigeration connection tube of the disclosure.

Non-limiting examples of the refrigerant-circulating component 410 can include one or more of evaporator subunits, condenser subunits or compressor subunits. The tube 100, including the flexible section of tubing 110, can connect (as part of a suction line, discharge line liquid line refrigerant or other refrigerant circulating lines) the refrigerant-circulating component to another one of the evaporator subunit, condenser subunit or compressor subunit, or, other refrigerant-circulating components familiar to those skilled in the art.

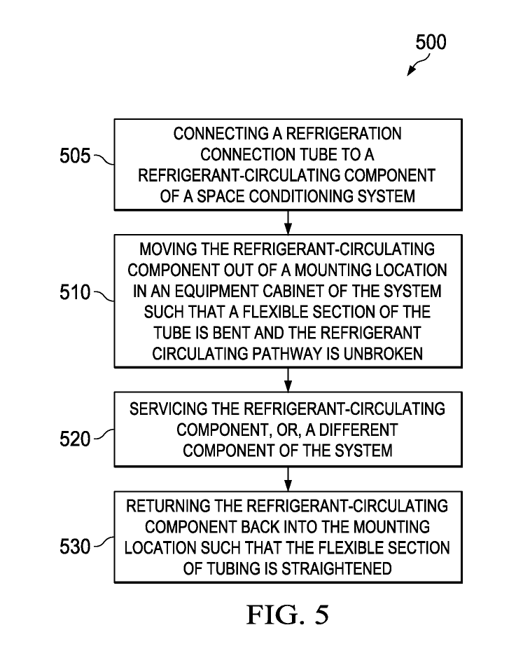

Another embodiment of the present disclosure is a method. FIG. 5 presents a flow diagram of an example method 500 of the disclosure, such as implemented by any of the systems 400 and tubes 100 discussed in the context of FIGS. 1A-4B.

With continuing reference to FIGS. 1A-4B throughout, the example method 500 presented in FIG. 5 includes, a step 505 of connecting a refrigeration connection tube 100 to a refrigerant-circulating component 410 of a space conditioning system 400. The refrigeration connection tube 100 can comprise any of the embodiments of the refrigeration connection tube 100 discussed in the context of FIGS. 1A-3. At least a section 110 of the refrigerant connection tubing is flexible, the flexible section of tubing 110 including a ribbing 115. The ribbing 115 circumscribes the flexible section of tubing 110 in a direction 120 that is substantially perpendicular to a long axis 125 of the flexible section of tubing 110. The ribbing 115 traverses an entire thickness of the flexible section of tubing 110.

Some embodiments of the method 500 can further include a step 510 of moving the refrigerant-circulating component 410 out of a mounting location 470 in an equipment cabinet 465 of the system 400 such that the flexible section of tubing 110 is bent (FIG. 5) and a refrigerant circulation pathway 455 between the refrigerant-circulating component 410 and the refrigerant tubing 100 is unbroken.

In some embodiments, the method 500 further includes a step 520 of servicing the refrigerant-circulating component 420 (e.g., an evaporator subunit), or, a different component 450 (e.g., a blower motor) of the system 400 that was obstructed by the refrigerant-circulating component 410 prior to moving the refrigerant-circulating component out of the mounting location 465.

In some embodiments the method 500 also includes a step 530 of returning (e.g., after the servicing step 520) the refrigerant-circulating component 410 back into the mounting location 465 such that the flexible section of tubing 110 is straightened.

In certain preferred embodiments throughout the moving step 510, servicing step 520 and returning step 530, the refrigerant circulation pathway 455 between the refrigerant-circulating component 410 and the refrigerant tubing 100 is unbroken.

Those skilled in the art to which this application relates will appreciate that other and further additions, deletions, substitutions and modifications may be made to the described embodiments.

What is claimed is:

1. A refrigeration connection tube, comprising:
a flexible section of tubing that include a ribbing, the ribbing circumscribing the flexible section of tubing in a direction that is substantially perpendicular to a long axis of the flexible section of tubing and the ribbing traversing an entire thickness of the flexible section of tubing.

2. The tube of claim 1, wherein the flexible section of tubing is configured to be reversibly bendable to form an angle of at least about 45 degrees without crimping.

3. The tube of claim 1, wherein the ribbing spirals in a direction that follows the long axis of the flexible section of tubing.

4. The tube of claim 3, wherein the ribbing that spirals around the flexible section of tubing makes at least one turn for every one-inch-length along the long axis of the flexible section of tubing.

5. The tube of claim 3, wherein the ribbing that spiral around the flexible section of tubing make about three to five turns per one-inch-length along the long axis of the flexible section of tubing.

6. The tube of claim 1, wherein the ribbing includes a plurality of independent ribs that each independently circumscribes the flexible section of tubing.

7. The tube of claim 6, wherein at least one of the independent ribs is located along every one-inch-length of the long axis of the flexible section of tubing.

8. The tube of claim 6, wherein from two to five of the independent ribs are located per every one-inch-length of the long axis of the flexible section of tubing.

9. The tube of claim 1, wherein the flexible section of tubing has a thickness of at least about 0.035 inches.

10. The tube of claim 1, wherein the flexible section of tubing has an outer diameter of at least about ¾ inches.

11. The tube of claim 1, wherein the flexible section of tubing is composed of aluminum or an aluminum alloy.

12. The tube of claim 1, wherein the flexible section of tubing is composed of copper or a copper alloy.

13. The tube of claim 1, wherein smooth sections of non-ribbed end-fittings are brazed the ends of the flexible section of tubing.

14. A space conditioning system, for conditioning air within an enclosed space, comprising:
a refrigerant-circulating component; and
a refrigeration connection tube connected to the refrigerant-circulating component, wherein at least a section of the refrigeration connection tube is flexible, the flexible section of tubing including a ribbing, the ribbing circumscribing the flexible section of tubing in a direction that is substantially perpendicular to a long axis of the flexible section of tubing and the ribbing traversing an entire thickness of the flexible section of tubing.

15. The system of claim 14, wherein the refrigerant-circulating component includes an evaporator subunit and the refrigerant tubing is part of a suction line that connects an outlet of the evaporator subunit to an inlet of a compressor subunit.

16. The system of claim 14, wherein the refrigerant-circulating component includes at least one of an evaporator subunit, condenser subunit or compressor subunit, and, the tube including the flexible section of tubing connects the refrigerant-circulating component to another one of the evaporator subunit, condenser subunit or compressor subunit.

17. A method, comprising:
connecting a refrigeration connection tube to a refrigerant-circulating component of a space conditioning system, wherein at least a section of the refrigerant connection tubing is flexible, the flexible section of tubing including a ribbing, the ribbing circumscribes the flexible section of tubing in a direction that is substantially perpendicular to a long axis of the flexible section of tubing, and the ribbing traverses an entire thickness of the flexible section of tubing.

18. The method of claim 17, further including:
moving the refrigerant-circulating component out of a mounting location in an equipment cabinet of the system such that the flexible section of tubing is bent and a refrigerant circulation pathway between the refrigerant-circulating component and the refrigerant tubing is unbroken.

19. The method of claim 18, further including:
servicing the refrigerant-circulating component, or, a different component of the system that, e.g., was obstructed by the refrigerant-circulating component prior to moving the refrigerant-circulating component out of the mounting location.

20. The method of claim 19, further including returning the refrigerant-circulating component back into mounting location such that the flexible section of tubing is straightened.
